(19) United States
(12) Patent Application Publication
(10) Pub. No.: US 2006/0270581 A1
(43) Pub. Date: Nov. 30, 2006

(54) Fabric whitener

(76) Inventor: David Toms, Kent (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 10/554,478

(22) PCT Filed: Jan. 27, 2004
(86) PCT No.: PCT/GB04/00322

§ 371 Date: Oct. 24, 2005

(30) Foreign Application Priority Data
Apr. 25, 2003 (GB) 0309507.2

(51) Int. Cl. C11D 3/39

(52) U.S. Cl. 510/307

(57) ABSTRACT

A composition for the whitening of domestic fabrics which include a nylon and/or lycra component, said composition comprising thiourea dioxide and an alkali.

### BACKGROUND OF THE INVENTION

### Field of the Invention

The present invention relates to a product for whitening fabric articles which have become discolored, in particular lingerie or underwear fabric items made from or containing nylon which have become discolored due to color runs or a build up of dye during repeated washing.

It is known that white fabric items, in particular lingerie, become discolored with repeated washing over time, taking on a grey or dirty blue tinge, which is regarded by the consumer as being dirty. It has been found by our research that this discoloration is due in a large part to a very slow color run from colored articles washed at the same time and which contain non-fast dye. Often when sorting their washing into colored and white wash loads, consumers include light blue items and mainly white items (but with a little color) in the white wash load.

Previously it was thought that most of the discoloration on the white fabrics was a result of dirt becoming entrained in the white fabric. However, our research shows that a small amount of loose dye is released from the colored article in each wash and transfers to the white article. The color thus builds up on repeated washing with colored articles. This is difficult to remove, especially if the white article and the dye have a strong affinity for each other.

Discoloration occurs on most fabrics, but is particularly a problem on nylon and lycra (which each have a strong affinity for non-fast dyes) and to a lesser extent cotton and polyester. There are no products available which will restore this lost whiteness to articles containing nylon and/or lycra which have started to discolor. White lingerie is largely made up from a combination of these materials and is therefore prone to this form of discoloration over time, turning a blue or grey color. In some cases this can occur very quickly if the light washing load generally includes a large amount of non-fast dye, in particular from blue articles, in the machine.

Some products on the market attempt to prevent non-fast dye from discoloring light or white items in the first place by using bleaches or dye scavengers. The object of these products is to pick up any loose dye in the wash before it becomes attached to the white item. Alternatively, they may effectively bleach the non-fast dye while it is loose in the water so that it loses its color before it attaches itself to a light item. These dye scavenger products do not treat items which have previously become discolored.

There are products on the market designed to remove color runs, but these products are only effective on certain fabric types; they are not effective on nylon and lycra which are major constituents of lingerie and underwear. It is also not readily understood by the consumer that the grey discoloration is from a run of colored dye because this builds up slowly over time.

Industrially, dye removal is operated under very severe conditions. Reducing agents are used at their boiling point, usually with caustic soda, to bleach the fabric to remove the color. Very occasionally, chlorine bleach may be used to strip out dye, but this may damage the structure of the fabric material permanently and can subsequently cause white fabric to have a yellow or orange hue. This discoloration can not be treated as the chemical structure of the fabric has been altered.

Dilute chlorine bleach solutions can also be used domestically to treat light or white items, but again this can irreparably damage the chemical structure of the fabric.

The present invention seeks to overcome the problems of the prior art. A first object is to provide a product which restores the whiteness in discolored nylon and/or lycra fabrics in a domestic environment.

### SUMMARY OF THE INVENTION

According to the present invention, there is provided a composition for the whitening of domestic fabrics which include a nylon and/or lycra component, said composition comprising thiourea dioxide (formamidesulphinic acid) and an alkali. The invention is particularly suitable for use in whitening nylon and lycra which are perceived as being difficult to treat using conventional materials. Among domestic garments which can be treated using the compositions of the present invention are lingerie and underwear items which usually include a nylon element.

The thiourea dioxide operates as a reducing agent and is preferably present at a concentration of at least 2.5% on weight of fabric, more preferably 2.5 to 10%, and most preferably 6 to 10%. Surprisingly, thiourea dioxide has been shown to give substantially superior results when compared to other reducing agents such as sodium hydrosulphite and sodium formaldhydesulphoxylate, even when much higher concentrations of these other materials are used.

Preferably, the alkali is present in an amount to give a pH greater than 7.0, more preferably greater than 8.0, and most preferably in the range 8.5-10.0.

Preferably, the treatment is carried out at a temperature of greater than 40° C., more preferably in the range 50 to 65° C., and most preferably at approximately 60° C.

Optionally, the composition further comprises a dye scavenger component. These compounds are often referred to as dye transfer inhibitors (DTI), and pick up loose or non-fast dye in the solution to prevent most or all of the loose dye from becoming attached to the light fabrics at all. These compounds do not generally remove dye which has previously become permanently attached to the fabrics. Preferably the dye scavenger is selected from the list of polyvinylpyrrolidone and poly(4-vinylpyridinium N-oxide), most preferably poly(4-vinylpyridinium N-oxide). Preferably this is present at a concentration of greater than 0.2% on weight of fabric, more preferably at a concentration of approximately 0.4%.

The invention also extends to a method of treatment to remove discoloration from domestic white fabric articles which include a nylon and/or lycra component, in which the fabric article is treated with a composition including thiourea dioxide and an alkali. A preferred treatment method comprises the steps of soaking the article in a solution of the composition of the present invention, followed by a water rinse and a conventional washing cycle. Other preferred features of the composition set out above apply equally to the method of the invention.

### DETAILED DESCRIPTION OF THE PREFERRED EMBODIMENT

The present invention may be put into practice in a number of different ways and various embodiments will described here in further detail by way of non-limiting example.

Samples of white nylon were stained with various different color dyes by soaking them in a solution of the dye. In all instances 0.05 g dye per kg of nylon were dissolved in water and the fabric was treated with this solution at 60° C. in a washing machine cycle, and then spun and dried at ambient temperature to stain the fabric. Once treated, the discolored samples were measured for “whiteness” using a Datamaster V.2.3 spectrophotometer. These results are in the form of delta E (ΔE), or color strength, and original white fabric produces a reading of 0.00. The lower the ΔE value, the whiter the fabric.

C.I. Direct Red 81 was the primary dye used, as it was easier to see the visual effects of the treatments with a red dye than with a blue dye. However, tests were also conducted using C.I. Direct Blue 251 and C.I. Direct Yellow 27.

The dyed samples were treated with a variety of products under the conditions set out below. The conditions were the same for all examples unless otherwise indicated.

250 g of stained fabric was treated in 7.5 litres of water which included the indicated amount of the active component and with an initial pH of 9.9 unless otherwise indicated to the contrary. The water was initially at 60° C. and the treatment lasted 30 minutes with the solution being stirred initially and then occasionally over the 30 minutes. There was no external heating of the solution over the 30 minutes, so the solution cooled during the treatment. After removal from the treatment solution the fabric sample was rinsed under cold tap water, and then washed in a normal washing cycle at 40° C. using a standard detergent. In the following tables, “o.w.f.” is an abbreviation for “on weight of fabric”

### EXAMPLE 1

Effect of Concentration of Thiourea Dioxide at a pH of 9.9.

Samples were treated with different concentrations of thiourea dioxide as the active component and the results are given in table 1 below.

TABLE 1

| Treatment | Δ E |
|---|---|
| Stained, untreated | 16.05 |
| Thiourea dioxide 10% o.w.f | 6.44 |
| Thiourea dioxide 5% o.w.f | 6.11 |
| Thiourea dioxide 2.5% o.w.f | 6.91 |
| Thiourea dioxide 1.25% o.w.f | 11.66 |
| Thiourea dioxide 0.63% o.w.f | 13.18 |

From these results it can be seen that a minimum of 2.5% o.w.f thiourea dioxide is desirable to obtain significant whitening of the nylon. It can also be seen that increasing the concentration of the thiourea dioxide further does not significantly increase performance.

### EXAMPLE 2

Effect of pH on Thiourea Dioxide.

Samples were treated with thiourea dioxide at a concentration of 10% o.w.f. at different pH by altering the concentration of alkali present in the solution. The results are given in table 2 below.

TABLE 2

| pH | Δ E |
|---|---|
| Stained, untreated | 16.05 |
| pH 9.9 | 6.44 |
| pH 9.0 | 5.21 |
| pH 8.0 | 8.98 |
| pH 7.0 | 8.77 |
| pH 5.0 | 11.34 |

From these results it can be seen that the treatment is more effective under alkaline conditions, and in particular at a pH around 9.0.

### EXAMPLE 3

Effect of Temperature

Samples were treated with thiourea dioxide (10% o.w.f.) at a range of temperatures and the results are given in table 3 below.

TABLE 3

| Temperature | Δ E |
|---|---|
| Stained, untreated | 16.05 |
| 40° C. | 12.99 |
| 50° C. | 8.07 |
| 60° C. | 6.44 |
| 80° C. | 0.95 |
| 95° C. | 0.35 |

From these results it can be seen that a treatment temperature of at least around 50° C. is required to achieve significant whitening of the nylon. Treatment at higher temperatures produce even greater effects, but some care may be required if domestic treatment is to be carried out at these higher temperatures.

### Comparative Example 1

Effect of Concentration of Sodium Hydrosulphite.

The samples were treated with sodium hydrosulphite as active component in place of thiourea dioxide under the same conditions. The results are set out in table 4 below.

TABLE 4

| Treatment | Δ E |
|---|---|
| Stained, untreated | 16.05 |
| sodium hydrosulphite 20% o.w.f. | 7.11 |
| sodium hydrosulphite 10% o.w.f. | 7.46 |
| sodium hydrosulphite 5% o.w.f. | 10.85 |
| sodium hydrosulphite 2.5% o.w.f. | 11.96 |
| sodium hydrosulphite 1.25% o.w.f. | 12.60 |

From these results it can be seen that even at a concentration of 20% o.w.f. sodium hydrosulphite, the nylon is not as white as when treated with 2.5% o.w.f. thiourea dioxide.

### Comparative Example 2

Effect of poly (4-vinylpyridinium N-oxide) (a Dye Transfer Inhibitor) as a Whitener.

The samples were treated with poly (4-vinylpyridinium N-oxide) (hereinafter referred to as DTI) as active component in place of thiourea dioxide under the same conditions. The results are set out in table 5 below.

TABLE 5

| Treatment | Δ E |
|---|---|
| Stained, untreated | 16.05 |
| DTI 0.4% o.w.f. | 14.40 |
| DTI 0.2% o.w.f. | 15.18 |
| DTI 0.1% o.w.f. | 17.48 |
| DTI 0.05% o.w.f. | 20.22 |
| DTI 0.025% o.w.f. | 20.17 |

From these results it can be seen that DTI has little effect on its own as a whitener, although at concentrations above 0.2% o.w.f. some mild whitening effect can be seen.

### EXAMPLE 4

Effect of Combinations of Thiourea Dioxide and DTI at a pH of 9.9.

A composition including both thiourea dioxide and a dye transfer inhibitor (DTI) was tested under the conditions set out above, and the results are shown in table 6 below.

TABLE 6

| Treatment | Δ E |
|---|---|
| Stained, untreated | 16.05 |
| 10% thiourea dioxide o.w.f./DTI 0.4% o.w.f. | 4.60 |
| 5% thiourea dioxide o.w.f./DTI 0.2% o.w.f. | 5.70 |
| 2.5% thiourea dioxide o.w.f./DTI 0.1% o.w.f. | 7.50 |
| 1.25% thiourea dioxide o.w.f./DTI 0.05% o.w.f. | 8.29 |
| 0.63% thiourea dioxide o.w.f./DTI 0.025% o.w.f. | 12.49 |

From these results it can be seen that there is a synergistic effect of the reducing agent (thiourea dioxide) and the dye transfer inhibitor which produces results which are unexpectedly significantly better than using either component alone. For example, comparing the ΔE value from Table 1 for 10% thiourea dioxide with that for 10% thiourea dioxide and 0.4% DTI from Table 6, it can be seen that the nylon is whiter after treatment with the combined composition (4.6 c.f. 6.44).

### Comparative Example 3

Comparison with Commercially Available Products

A number of commercially available products for domestic cleaning and treatment which either claim to whiten fabric or to remove color runs from the wash liquid, thereby avoiding discoloration, were tested and compared with a product according to the present invention. The samples were all treated by the same method set out above. The results are set out in table 7 below.

TABLE 7

| Product treatment | Δ E |
|---|---|
| Stained, untreated | 16.05 |
| Glo-Care Rescue Colour Run Remover. 5% o.w.f. | 10.92 |
| Glo-White Super whitener. 3.4% o.w.f./Ariel | 17.85 |
| Essential 14% o.w.f. | |
| Vanish Tablets 8.8% o.w.f./Ariel Essential | 15.44 |
| 14% o.w.f. | |
| Ace Washbooster 30% o.w.f./Ariel Essential | 19.13 |
| 14% o.w.f. | |
| Ariel Essential 14% o.w.f. | 13.88 |
| Dylon Lingerie Whitener 10% o.w.f. thiourea | 4.60 |
| dioxide/0.4% o.w.f. DTI | |

It is clear that the commercially available products do not work effectively on nylon. Indeed, the most effective (Glo-Care Rescue), which is based on sodium hydrosulphite, states that it is not suitable for use on nylon. The present invention whitens nylon (amongst other fabrics) as shown in the table above.

### EXAMPLE 5

Samples were discolored with C.I. Direct Blue 251 instead of C.I. Direct Red 81, and the results of treatment with a variety of compositions are set out in table 8 below.

TABLE 8

| Treatment | Δ E |
|---|---|
| Stained, untreated | 7.15 |
| Effect of sodium hydrosulphite (20% o.w.f.) | 1.87 |
| Effect of thiourea dioxide (10% o.w.f.) | 1.71 |
| Effect of sodium hypochlorite (40% o.w.f. of | 14.55 |
| 15% available chlorine) | |

It will be apparent from these results that treatment with thiourea dioxide under alkaline conditions significantly whitens the nylon. Treatment with sodium hypochlorite (household chlorine bleach) removes the dye, but discolors the nylon-hence the high color strength. As indicated above, the use of chlorine also damages the underlying structure of the fabric.

### EXAMPLE 6

Samples were discolored with C.I. Direct Yellow 27 instead of C.I. Direct Red 81, and the results of treatment with a variety of compositions are set out in table 9 below.

TABLE 9

| Treatment | Δ E |
|---|---|
| Stained, untreated | 13.87 |
| Effect of sodium hydrosulphite (20% o.w.f.) | 13.86 |
| Effect of thiourea dioxide (10% o.w.f.) | 11.25 |
| Combination of thiourea dioxide/DTI (10% | 9.36 |
| o.w.f./0.4% o.w.f.) | |

Again, it will be apparent from the results that treatment with thiourea dioxide under alkaline conditions significantly whitens the nylon. It is also apparent that thiourea dioxide again produces a significantly better performance than sodium hydrosulphite, even at half the concentration. Further, it can be seen that the addition of DTI to the thiourea dioxide produces an even greater effect than thiourea dioxide alone, highlighting the synergy between the components.

These examples are not limiting and it will be apparent to a person skilled in the art that the results from the experiments described above are not dependent upon the dye which discolors the white fabric. Therefore, it is clear that the composition of the present invention is generally applicable to treatment in a domestic environment of white fabrics which include a nylon and/or lycra component.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A composition for the whitening of domestic fabrics which include a nylon and/or lycra component, said composition comprising thiourea dioxide and an alkali.

2. A composition as defined in claim 1, in which the thiourea dioxide is present at a concentration of at least 2.5% o.w.f.

3. A composition as defined in claim 2, in which the thiourea dioxide is present at a concentration of between 2.5 and 10% o.w.f.

4. A composition as defined in claim 1, in which the pH is greater than 7.0.

5. A composition as defined in claim 4, wherein the pH of said composition is greater than 8.0.

6. A composition as defined in claim 1, in which the composition is used at an initial temperature of greater than 40° C.

7. A composition as defined in claim 6, in which the initial temperature is in the range of 50-65° C., preferably 60° C.

8. A composition as defined in claim 1, in which the composition further comprises a dye scavenger component.

9. A composition as defined in claim 8, in which the dye scavenger component is one of the group consisting of polyvinylpyrrolidone and poly(4-vinylpyridinium N-oxide).

10. A composition as defined in claim 9, in which the dye scavenger component is poly(4-vinylpyridinium N-oxide).

11. A composition as defined in claim 10, in which the poly(4-vinylpyridinium N-oxide) is present at a concentration of greater than 0.2% o.w.f., preferably about 0.4% o.w.f.

12. A method of treatment to remove discoloration from domestic white fabric articles which include a nylon and/or lycra component, in which the fabric article is treated with a composition as defined in claim 1.

13. A method of treatment as defined in claim 12, in which the treatment comprises the steps of soaking the article in a solution of the composition as defined in claim 1, followed by a water rinse and a conventional washing cycle.

14. A composition as defined in claim 3, wherein said thiourea dioxide is present at a concentration of between approximately 6 and 10% o.w.f.

15. A composition as defined in claim 5, wherein the pH of said composition is in the range of approximately 8.5 to 10.0.

16. A composition for the whitening of a domestic fabric which includes a nylon and/or a lycra component, wherein the fabric is discolored having a initial color strength value, said system comprising:
an alkaline thiourea dioxide component capable of whitening the fabric to a first color strength value of the fabric below the initial color strength value of the fabric at an effective amount of thiourea dioxide component; and
a dye scavenger component capable of whitening the fabric to a second color strength value below the initial color strength value of the fabric at an effective amount of dye scavenger component;
wherein the combination of the effective amounts of thiourea dioxide component and dye scavenger component whitens the fabric to a color strength value below the initial color strength value of the fabric, the first color strength value, and the second color strength value.

17. A composition as defined in claim 16, wherein the pH of the alkaline thiourea dioxide component is in the range of approximately 8.5 to 10.0.

18. A composition as defined in claim 16, wherein the thiourea dioxide is present at a concentration of at least approximately 2.5% o.w.f.

19. A composition as defined in claim 16, wherein the dye scavenger component is selected from polyvinylpyrrolidone, poly(4-vinylpyridinium N-oxide), and combinations thereof.

20. A composition as defined in claim 16, wherein the poly(4-vinylpyridinium N-oxide) is present at a concentration of greater than 0.2% o.w.f., preferably about 0.4% o.w.f.

21. A method of treatment to remove discoloration from domestic white fabric articles which include a nylon and/or lycra component and have an initial color strength value, said method comprising:
providing an effective amount of thiourea dioxide in an aqueous medium in combination with an effective amount of a dye scavenger component; and
contacting the fabric with the combination under alkaline conditions.

22. A method as defined in claim 21, wherein the thiourea dioxide is present at a concentration of at least approximately 2.5% o.w.f.

23. A method as defined in claim 21, wherein the dye scavenger component is selected from polyvinylpyrrolidone, poly(4-vinylpyridinium N-oxide) and combinations thereof.

24. A method as defined in claim 21, wherein the fabric is contacted with the combination at a pH greater than 7.0.

25. A method as defined in claim 21, wherein contacting the fabric comprises soaking the fabric until a color strength value below the initial color strength value is achieved.

26. A composition for the whitening of domestic fabrics which include a nylon and/or lycra component, wherein the fabric is discolored having a initial color strength value, said composition comprising:
thiourea dioxide and an alkali in an aqueous medium;
wherein said thiourea dioxide is present in an amount effective to reduce the color strength value of the fabric below the initial color strength value of the fabric.
